(19) United States
(12) Patent Application Publication
(10) Pub. No.: US 2007/0128580 A1
(43) Pub. Date: Jun. 7, 2007

(54) Blank and method for producing a dental prosthesis

(76) Inventor: Jeanette Mörmann, Zurich (CH)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/568,122

(22) PCT Filed: Jul. 21, 2004
(86) PCT No.: PCT/CH04/00460

§ 371 Date: Jun. 23, 2006

(30) Foreign Application Priority Data
Aug. 15, 2003 (EP) 03405597.0

(51) Int. Cl. A61C 8/00

(52) U.S. Cl. 433/201.1

(57) ABSTRACT

The invention relates a blank for producing a dental prosthesis (tooth crown) comprising a mechanically processable material block (10) and a holder (11) connected thereto for clamping in an automatic processing tool. Said block (10) is provided with a sub-gingival anatomic implant connecting part (14) which is protrusively arranged thereon and in which an implant fixture for fixing it to the implant head is formed. The holder (11) is arranged on the surface (12) of the block (10) arrangement side and the implant fixture to a surface (13) on the implant side, thereby making it possible to work the blank by means of a computer-controlled conventional tool. A threaded channel which is embodied in the centre of the block (10) in a parallel direction with respect to the surface on the fixation side, the angular orientation of the mastication surface of the tooth crown with respect to the occlusion vertical and the sub-gingival anatomic implant connecting part (14) make it possible to fix the prosthetic element (tooth crown) directly to the implant without an abutment and with correct orientation in the row of teeth.

### CROSS REFERENCES TO RELATED APPLICATIONS

This application claims the priority of European patent application No. 03 405 597.0, which was filed on Aug. 15, 2003, and whose whole disclosure is herewith incorporated by reference.

### TECHNICAL FIELD

The invention relates to a blank and a method for producing a dental prosthesis, as well as to a kit of parts with such a blank according to the preamble of the independent claims. In particular, the method describes manufacturing crowns by means of CAD/CAM, CAM or copy-grinding apparatuses as prosthetic supra structures for dental implants using blank blocks of prosthetic material that are provided with an integral sub-gingival anatomic implant connecting part, which has an implant-typical fixture and allows the direct connection of a crown made of the block to the head of the dental implant.

### BACKGROUND ART

A conventional blank block, however in form of a slab, is known from EP 1 062 916 for a dental CAD/CAM system that is used in a large dental laboratory to produce an individual bridge-like prosthesis using documentation provided by the dentist.

The majority of implants have inclinations of the axes that deviate from those of the axes of neighboring teeth. This deviation is conventionally (also in EP 1 062 916, FIG. 5) compensated for during the design and manufacture of a crown by tapering the abutment towards the chewing surface. In EP 1 062 916, this is done in consideration of the so-called basic data about the jaw status and the location of the implant auxiliary elements, from which the inclination, the implantation depth, the position of the implant and the orientation of the positioning element, for example, hex etc., are determined. Furthermore, so called abutment data are generated (for example, by means of a wax-up). Then, an individual abutment is produced of a blank block in the CAD/CAM apparatus by means of an all-side chip removing process. With the help of so called insertion data, the abutments are shaped so that the crowns can be attached in consideration of the insertion direction. When using a converted standard abutment, this abutment must be individualized mechanically to be axially compliant. According to the known prior art (EP 1 062 916, FIGS. 8A, 8B, 8C, 8D), the abutments can be produced directly from the blank slab. The blank in form of a slab has in each of the areas, from which the abutments are made, a positioning element 16. The positioning elements 16 may be any rotation-blocking implant connecting forms, for example, a hexagon, octagon, rhombus, an oval cylinder, which according to EP 1 062 916, FIG. 8B, all extend outwardly. In this embodiment, several connecting parts may be produced from one slab, which are each intended for attachment on an implant.

EP 1 062 916 discloses further how to manufacture so called “integral parts” from a blank slab in one machining step and the same material.

The manufacture of crowns for the provision of implants by means of computer design occurs typically via the intermediate step of producing implant abutments in form of a snag (Hegenbarth 1999, Implantologie 3: 297-307), this is in analogy to the manufacture of crowns for still existing natural teeth. On these, the dentist prepares the still existing hard tooth substance to an arrow-like snag form, which follows substantially the tooth axis and an insertion axis, which is circularly convergent towards the chewing surface or the occlusion plane, and which is suitable for reception of the artificial full crown. With dental implants, occurring deviations of the axial alignment with respect to the occlusion plane of up to 20 angular degrees may be compensated for by means of the alignment of the implant abutment. For the manufacture of implant abutments and crowns, the precise determination of the position of the implant itself and also of the gums surrounding the head of the implant is of utmost importance. Both determine the anatomically correct shape of the implant abutment in the sub-gingival area. The outline of the crown in the gingival area should resemble that of the natural root of the tooth. The transition to the crown (emergence profile) likewise orientates itself towards the natural tooth to achieve a natural gingival outline. By means of a guide pin and a T-bar provided with a scale the position of the implant is transferred three dimensionally to the processor of the computer. While the guide pin screwed onto the implant depicts the oro-buccal and mesio-distal orientation of the implant, the T-bar reflects the height position of the implant head in the gingival area of the model. The inclination of the axis and the height position of the implant head are therewith known for the individual design of the abutment (Hegenbarth 1999, Implantologie 3: 297-307). This is made of titanium or high performance ceramic. The crown matching thereto is produced by means of dental or computer engineering steps.

The Cerec CAD/CAM system (Sirona Dental Systems, Bensheim, Germany), is suitable for the provision of teeth with full crowns made of ceramic (Mörmann et al., ISBN 3-9521752-1-8). For the manufacture of crowns using Cerec, up to now the implants are built by means of standard abutments made of titanium or ceramic. Unfavorable inclinations of the axes of dental implants can be compensated for by means of angled standard abutments. Alternatively, the angle of convergence and the gingival border of standard abutments made of high performance ceramic (for example, ZiReal available from Implant Innovations, Inc.) can be adapted by manual grinding. Abutments with a suitable stump direction and a sufficient angle of convergence can be recorded both with the Cerec-3D mouth camera and, after impression and model making, with the laser scanning in the Cerec inLab apparatus. The construction and manufacture of the crown occurs then on the stump by means of known steps, as on the vital tooth (Masek 2003, Int J Comp Dent 6: 75-82; W. Schneider, “Cerec 3D-A New Dimension in Treatment”, Int. J. Comp. Dent 6: 57-66 (2003)). The crowns are subject to form-grinding in the Cerec 3 grinding unit of blank blocks of grindable prosthesis material (ceramic, composite material) (Mörmann & Bindl 2000, Quintessence Int 31: 699-712; Mörmann & Bindl 2002, Dent Clin N Am 46: 405-426). This occurs in similar manner in other known systems for manufacturing dental prostheses, for example, the manually controlled Celay copy technique (Crispin 1996, Quintessence, Chicago, page 68), the DCM/Cercon technique (Filser et al., 2001, Int. J. Comp. Dent. 4: 89-106), the LAVA technique (Sutter et al. 2001, Int. J. Comp. Dent. 4 : 195-206), the DCS technique (Besimo et al. 2001, Int. J. Comp. Dent. 4: 243-262), the GN-1 technique (Hikita et al. 2002, Int. J. Comp. Dent. 5: 11-23). In each case, the CAD/CAM manufacture of implant crowns requires according to the conventional procedures the production of an axially conform abutment with the subsequent insertion and fastening of the crown.

In the effort to simplify the provisioning of crowns for dental implants it has been proposed to form implant fixtures in blocks of material and to make abutments and crowns by means of the CAD/CAM technology (abutments) (De Luca 1999, EP 1 023 876 A2).

However, this solution cannot be used with conventional processing system, for example, of the Cerec type, without structural modifications.

### SUMMARY OF THE INVENTION

The provisioning of dental implants with abutment full crowns poses a demanding and time consuming task, which is to be simplified and reduced by the present invention, preferable in the direct use in the dental office by the dentist in one patient sitting without intermediate steps by a dental technician.

This task is solved by the invention defined in the independent claims.

In all embodiments of the invention, the block is provided with a sub-gingival anatomical implant connecting part, in which an implant fixture for attaching to an implant head is formed. The implant connecting part has a sub-gingival section that extends over a surface of the block that faces the implant. This is for filling out at least partially the sub-gingival area formed by a healing cap between gingival border and implant shoulder, and for supporting the dental prosthesis formed from the block by means of a chip removing process. Thanks to the sub-gingival section the block does not need to be processed in this area thereby reducing the processing time and tool wear.

In a preferred embodiment, the sub-gingival section tapers towards the seat of the implant fixture, and has an anatomically adapted form, to which the gingiva can adapt. In other words, the cross-section of the sub-gingival section is at the level of the surface of the block larger than at the level of the seat of the implant head.

Preferably, the cross-section of the subgingival section decreases towards the seat continuously and monotonically. The term “monotonic” is to be construed in a mathematical sense, i.e., the cross-section decreases with increasing depth or remains over certain sub-regions (e.g., over the below-mentioned second subsection) constant. Likewise, the term “continuous” is to be construed in a mathematical sense and implies that the area of the cross-section should not change stepwise because resulting edges may cause an irritation of the gingiva.

Particularly in the area of the sub-gingival section following the surface of the block its cross-section area should be strictly monotonic decreasing, i.e., decreasing with increasing distance from the surface, so that the sub-gingival section has outer surfaces that widen towards the block. So-formed surfaces can merge with in this area likewise widening outer surfaces of the dental prosthesis without major angular changes.

In a further aspect of the invention, the outer surface of the sub-gingival section, which extends over the surface of the block, is pre-polished.

This is contrary to solutions in which the area bordering to the seat of the implant fixture is machined. The machining of ceramic occurs with diamond-coated tools with D 64 (or D 126) graining and leaves rough surfaces with Ra values (D 64) between 1.2 and 1.6 (Feher & Mörmann; Schweiz Mschr Zahnmed 105: 474-479 (1995). Sub-gingival rough surfaces of this kind are demonstrably aiding inflammations and are, hence, pathogenic (Mörmann et al.: J Clin Periodontol 1, 120-125 (1975). Therefore, prior to the insertion to the implant or the contact with the gingiva tissue, rough surfaces need to be polished or glazed by the dental technician with a surface roughness, which is equivalent to a machine polish (Ra 0.050+/−0.01) (Féher & Mörmann; Schweiz Mschr Zahnmed 105: 474-479 (1995), and which can be called gingiva friendly. According to the claims, this problem is avoided by the combination of two elements, namely, 1. the chip removing processing of the crown blank and 2. the not-to-be-processed sub-gingival section with a pre-polished, i.e., smooth, gingival-friendly surface. Preferably, the surface has an Ra value that is less than 0.1, in particular in the range of Ra=0.05+/−0.01.

The sub-gingival anatomic implant connecting part is preferably form-fittingly connected to the blank block. The control software for the chip-removing processing takes into account the boundary between these two elements.

In a further aspect of the invention, the sub-gingival section extends at least 1.5 mm, preferably at least 2 mm, beyond the surface of the block. It shows, that an individual chip-removing processing of the dental prosthesis is not necessary in an area of at least 1.5 mm (usually even at least 2.0 mm) of the implant head.

Preferably, the sub-gingival section has no rough edges so that the risk of irritating the gingiva can be reduced.

Preferably, the block is attached to a mount or processing apparatus on at least one surface facing the fastening means. This surface is perpendicular or at least transverse to the implant-sided surface of the block. Hence, the implant-sided surface (and the surface opposite the implant-sided surface) can remain freely accessible for the processing tools, at least in a middle section. This allows the occlusive gingival screw channel axis of the crown to be made, which axis is determined by the axis of the implant, to align parallel to the mount-sided surface or perpendicular to the axis of the mount, as is the case with the processing of conventional blank blocks.

The sub-gingival anatomic implant connecting part allows, for example, the dentist in the dental office to construct, at a stretch on the patient, full crowns directly on the head of the incorporated dental implant without complex intermediate steps by a dental technician dispensing with the manufacture and installation of an abutment, to form-grind the crowns in CAD/CAM devices or dental copy-processing devices while the patient is waiting, and to attach the crown position-appropriately in the mouth directly to the fixture of the dental implant.

The data for form-grinding the crown can, for example, be obtained by optical measurement on the exposed head of the dental implant or optical measurement of a measuring abutment placed on the implant directly in the mouth of the patient (e.g., using the CEREC camera) or by means of laser-scanning a dental-technically produced scanning models of this section (e.g., with the CERECinLab, DCS or GN-1 methods). In the second case, a representative implant can be precisely placed with the help of a measuring abutment. On top of this, a representative sub-gingival anatomic implant connecting part is attached and the crown is waxed-up according to the situation. The waxed-up crown including the sub-gingival anatomic implant connecting part is then scanned spatially by means of the known laser triangulation (DCM-Cercon, Lava, DCS, GN-1, CEREC inLab). The implant connecting part serves thereby as a reference for the orientation of the dataset in the blank block. Then, a blank block with the sub-gingival anatomic implant connecting part is form-grounded using these data.

Preferably, the implant connecting part 14 is made of a different material than the block 10, for example, a material with increased tensile strength so that the block 10 and the connecting part 14 can each be adapted to the different requirements they have to satisfy.

However, it is possible that the implant connecting part and the block are made of the same material and in particular configured as an integral piece. In this case, a material having high increased tensile strength should be used. The implant connecting part should thereby have the above-mentioned smooth surface, which does not need to be processed by a chip removing process.

Particularly advantageous is in this connection glass-ceramics, in particular lithium silicate ceramic, or another material that, after the machining in the CEREC apparatus by means of an after-treatment, in particular tempering, i.e., treatment at increased temperature, may be provided with an increased tensile strength.

The invention relates further to a kit of parts for the manufacture of a dental prosthesis, in particular a dental crown, with at least one blank of this kind.

Preferably, the position of the implant connecting part is measured and the blank is processed so that the predetermined surface of the prosthesis is formed relative to the position of the implant connecting part.

These steps ensure that the surface of the prosthesis has the correct position with respect to the implant connecting part and, hence, the implant.

### BRIEF DESCRIPTION OF THE DRAWINGS

The invention will be better understood and objects other than those set forth above will become apparent when consideration is given to the following detailed description thereof. Such description makes reference to the annexed drawings, wherein:

Further advantages and applications of the invention result from the following description with reference to the drawings. In the drawings:

FIG. 1 shows a side view of a row of teeth with a tooth to be replaced;

FIG. 2 shows a top view of the row of teeth of FIG. 1;

FIG. 3 shows the row of teeth of FIG. 1 with measurement abutment;

FIG. 4 shows a top view of the row of teeth of FIG. 3;

FIG. 5 shows a cut through a blank with mount;

FIG. 6 shows the blank of FIG. 5 as seen from the side of the fixture;

FIG. 7 shows the blank of FIG. 5 with reference part;

FIG. 8 shows the blank of FIG. 7 as seen from the side of the reference part;

FIG. 9 shows the restored row of teeth;

FIG. 10 shows a second embodiment of a blank;

FIG. 11 shows a model made by a dental technician with waxed-up abutment, wherein the latter is represented in section; and

FIG. 12 shows a detailed representation in section through the blank in the area of the implant connecting part.

### WAYS TO PRACTICE THE INVENTION

In the following, an embodiment of the invention is described with reference to an example. The subject matter is thereby the restoration of a molar with a crown.

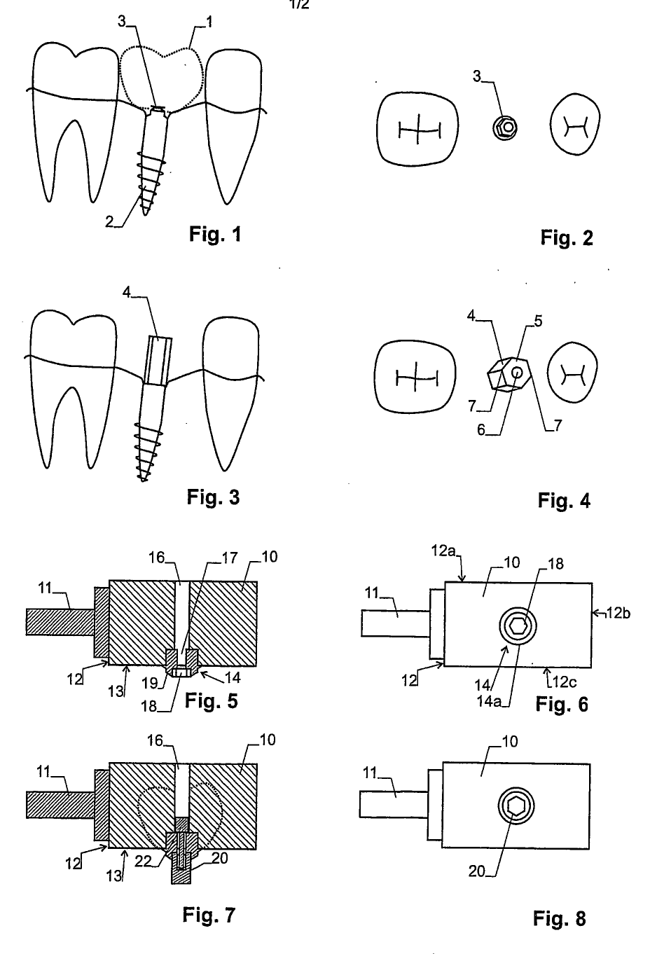

FIGS. 1 and 2.show a row of teeth with missing molar 1 (interdental space), on whose position a dental implant 2 has been anchored in the jaw-bone. The head 3 of the dental implant 2 has in known manner a polygonal profile and an internal thread, which form a fixture and serve as attachment for the restoration (crown).

The situation of the exposed implant head 3 is measured three-dimensionally. For that purpose, the three-dimensional location and position of the implant head is, analog to the dentistry, determined using an auxiliary body, hereinafter referred to as “measurement abutment” 4, as shown in FIGS. 3 and 4. The measurement abutment 4 fits precisely on the fixture of the implant head 3 and is screwed onto it for an exact fit so that it stands in a predetermined position with respect to the implant head 3. The measurement abutment 4 extends the intra ossuary placed dental implant 2 in its axial direction towards the area of the clinical dental crown. It has a prismatic form with preferably hexagonal or octagonal cross-section depending on the geometry of the fixture. Its side surfaces end occlusally in an area 5, which is interrupted by a borehole 6 for the central fastening screw. The occlusal area 5 of the measurement abutment 4 represents the spatial form and position of the implant head in the gingival-cervical area with the distance, which is defined by the height of the measurement abutment 4. Further, it informs about the angular deviation of the implant with respect to the plane of the chewing surface (occlusion). The measurement abutment 4 has opaque surfaces that are suitable for the optical three-dimensional measuring, and lies together with the occlusal area in the area of focus and measurement range of the measurement system. For the oral optical three-dimensional measurement using the Cerec-3D mouth camera the gingival and neighboring teeth are covered with an opaque powder or spray.

Together with the measurement of the position and location of the implant 2, the size and form of the tooth gap are measured in known manner, as well as the position of neighboring teeth.

The determination of the form of the crown is carried out, for example, using the software of the above-mentioned CEREC system, which includes the modifications characterizing the method. The situation determined by the measuring system is thereby shown on a display and the user marks relevant points and lines. Starting point is the measured and stored form, position and location of the implant head 3. In a first step, the user identifies in the virtual model of the tooth or jaw area the outer border of the occlusal hexagonal or octagonal area 5 of the measurement abutment 4 with a line, and further the mesial and distal corners 7, which are closest to the axis of the mesial-distal row of teeth, by means of inputting points. The connecting line of these points 7 through the center marks the angular position of the implant fixture with respect to the axis of the mesial-distal row of teeth. Through this input, the system experiences the angular deviation of the implant fixture with respect to the axis of the mesial-distal row of teeth, as well as its mesial-distal or oro-buccal spatial orientation. The axis of the mesial-distal row of teeth represents together with the occlusal plane the main axis for the construction of the crown. The stored spatial data of the implant head are assigned to the gingival cervical position by means of the spatial identification through the measurement abutment in the three-dimensional data model.

For determining the shape of the crown the outer circumference of the implant head 3 is in the first step marked by entering a closed circular base line, and the implant connecting part 14 with its spatially oriented contour 14a formed on the implant-sided surface of the blank block. For the construction of the crown, this is shown as a base line in the data model. In the second step, the cervical contour of the crown following the course of the border of the gingiva is entered. The height data of the base line are taken over from the height profile of the gingiva. The line can be edited. Between the outer border of the implant head 3 and the gingival-cervical contour of the crown the sub-gingival surfaces of the crown are generated, wherein the surface in proximity of the implant takes the implant-typical surface shape of the intended sub-gingival anatomical implant connecting part over from a database of implant-typical connecting parts. A virtual crown of the appropriate tooth type from a dental data base is fitted to the gingival edge of the crown, or a record of the situation that existed before the tooth was lost is used. The emergence profile of the buccal, lingual and approximate surfaces of the crown can be determined in the area of the cervical crown contour with a coronal exit angle. The mesio-distal, approximate and occlusal orientation and adaptation of the form of the crown is done using the tools of the available software. For the mechanical form-grinding of the implant crown the construction data are converted into grinding data.

A blank is then processed, as illustrated in FIGS. 5 and 6. It has a blank block or block 10, which is, for example, made of a ceramic material or composite, and a holder 11, which serves for holding in a computer-controlled machining tool. The holder 11 is connected with a holder-sided surface 12 of the block 10, for example, by means of gluing. Blanks of this kind are, for example, known from U.S. Pat. No. 4,615,678.

On a second surface 13, which is hereinafter referred to as implant-sided surface, and which is perpendicular to the holder-sided surface 12 of the block 10, precisely one sub-gingival anatomic implant connecting part 14 is provided. It concerns an implant-specific precision part made of a material having a high tensile strength, which provides for a precise fit of the crown on the implant head 3 and allows the firm screw connection with it. The sub-gingival anatomic implant connecting part 14 is firmly connected with the block 10. The block 10 has a central channel 16, which extends from the sub-gingival anatomic implant connecting part 14 across the block 10. The channel extends through the center of the block 10 and parallel to the holder-sided surface 12. It receives a fastening screw 12 and allows access to the screw 12 by means of a screw driver, so that the connecting part 14 together with the form-grounded crown can be screwed to the implant. The sub-gingival anatomic implant connecting part 14 is with its circumferential plane positioned coplanar to the implant-sided surface 13 of the block 13. The arrangement of the fixture geometry of the connecting part 14 is in a standardized arrangement with respect to the geometry of the block 10.

The implant connecting part 14 is, for example, made of metal or shatter-proof ceramic since it has to absorb high forces. It is partially countersunk and extends, as shown, in a sub-gingival section 19 partially over the surface 13. As initially mentioned, less material has to be removed from such a construction of the dental prosthesis during form-grinding.

The sub-gingival anatomic implant connecting part 14 has an axial opening 17 for the shaft of the fastening screw 12 and a polygonal (rotation-blocking) seat 18 that serves as a fixture and that is adapted to the form of the head 3 of the implant. For form-grinding the crown in the machining tool, the identification of the position of the sub-gingival anatomic implant connecting part 14 in the block 10 is important. This is done by means of a reference part 20 in form of a material body, as shown in FIGS. 7 and 8. The reference part 20 is connected to the sub-gingival anatomic implant connecting part 14 and is approached by the machining tool for identifying its position. The form and size of the reference part 20 are stored in the machine. The identification occurs, for example, through touching opposing axial sides and the end surface, or through optical scanning. If the implant connecting part 14 extends sufficiently over the implant-sided surface 13 of the block 10 its position can possibly be determined directly without a particular reference part. Further, it is possible to measure the position of the channel 16. If the position of the implant connecting part with respect to the holder 11 precisely known, a determination of the holder is possibly sufficient.

The crown construction to be grounded from the block 10 is oriented in the block 10 according to its connection to the implant connecting part 14. In case of tilting with respect to the plane of occlusion, as described further below in more detail, the whole crown construction is adjusted in the blank block according to the tilting. Likewise, the crown construction has to be turned more or less according to the rotational position of the seat with respect to the block 10—in case of a hexagonal seat 18 at most by +/−30°.

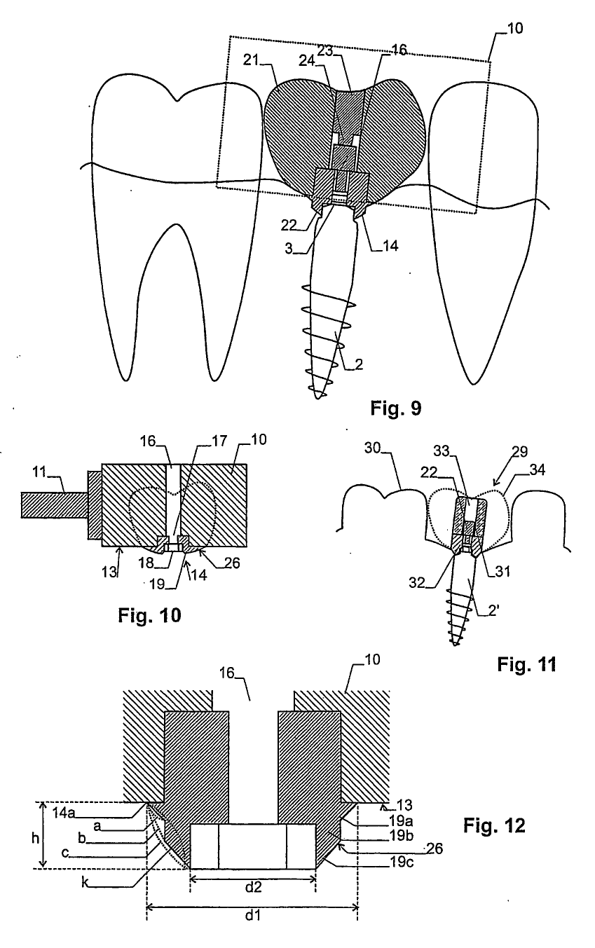

After the construction, a crown 21 is form-grounded in a known manner. As shown in FIG. 9, it can then be attached to the implant head 3 by means of introducing the fastening screw 22 into the channel 16 and screwing it to the implant 2. The channel 12 having, for example, a diameter of 2.5 mm is closed. For that, malleable material for dental prostheses or a closing plug 23 may be used. The latter, preferably made of the same material as the block 10, has a diameter adapted to the channel 16 and is glued into the channel 16 and beveled on the occlusal surface. If a closing plug 23 is used, preferably, it does not extend in its full thickness to the fastening screw 22 so that the fastening screw can be uncovered again, if necessary, without any damage. In a preferred embodiment, a distance element 24 is arranged on the tip of the closing plug 23 that is made of a different material (e.g., silicon) than the closing plug 23 and/or has a smaller cross-section than the closing plug 23. If the closing plug is bored out, the distance element 24 can be dismantled without mechanical damage to the screw.

Glass-ceramic is particularly suitable as material for the block 10, in particular a lithium-silicate ceramic or another material, for example, composite, feldspar ceramic or leucit glass ceramic.

By using a sufficiently firm material for the block 10, the implant connecting part 14 can be made of the same material as the block 10 and is preferably formed from it as an integral piece.

Preferably, however, the implant connecting part 14 is formed separately so that it can be produced with the necessary accuracy without great expense. In particular, if the sub-gingival implant connecting part 14 is made of metal, it can easily be produced accurately and yet has the necessary tensile strength. After its manufacture, the implant connecting part 14 is permanently anchored in the block 10.

The sub-gingival section 19 of the implant connecting part 14 butting against the gingiva has preferably three subsections 19a, 19b, 19c, as illustrated in FIG. 12. The first subsection 19a connects to the surface 13, the second subsection 19b to the first subsection 19a, and the third subsection 19c to the second subsection 19b.

The third subsection 19c is tapered and rests on the shoulder of the implant. The second section 19b is cylindrical. The first subsection 19a is again tapered. The height of these individual subsections can range between 0.5 and 2.0 mm, wherein the second subsection can have a height of up to 4 mm. The largest diameter of the third subsection 19c or the diameter of the second subsection 19b is 0.5 to 2 mm larger than the diameter d2 of the shoulder of the implant. The largest diameter d1 of the first subsection 19a is 1 to 4 mm larger than the diameter of the implant shoulder.

The three subsections 19a, 19b and 19c may have a circular cross-section. However, for the manufacture of molar crowns, in particular the first subsection 19 can, in deviation from the circular form, be formed mesio-distally oblong or elliptical with a longitudinal diameter of up to 12 mm and an oral-buccal transverse cross-section, which corresponds at least to the diameter of the second subsection or the diameter of the shoulder of the implant. If a high-strength material is used, it may serve in this configuration as support element for the supra-gingival material that forms the individual crown. For the provision of premolars, the first subsection 19a can be oriented oral-buccally oblong and transverse to the mesio-distal row of teeth with a diameter of up to 8 mm and with the minimal mesio-distal diameter of the distance element in order to take into consideration the anatomically low mesio-distal cross-section of the premolars.

The third subsection 19c and the second subsection 19b can be exchanged with respect to their outer contour, whereby a cup-shaped outer form (see line k in FIG. 12) of the gingival section 19 results. In this case, the first and second subsections 19a and 19b can be adjoining virtually indistinguishable and form an integral body that widens towards the implant-sided surface.

For the anatomical adaptation, the outer contour lines a, b, c shown in FIG. 12 illustrate further possible contours of the outer form of the section 19. With the preferable anatomically oriented configuration of the outer contour of the implant connecting part, the extension parts 1 and 2 and the distance part merge without rough edges.

The assembling ratios of the sub-gingival-anatomic implant connecting part 13 to the implant conform with the forms of known boltable implant connecting forms for abutments of all kind, for example, hex abutments or ZiReal posts of the firms 3i Implant Innovations (Switzerland), or like with synocta meso milling cylinders of the firm Straumann (Switzerland).

The maximal diameter d1 of the sub-gingival section 19 can be between 3.8 and 8.0 mm, with circularly continuous or beveled outer surfaces that open conically from the shoulder of the implant towards occlusal with angles between 40° and 70°.

Further, the conical surfaces raising from the shoulder of the implant can be configured spherically convex with similar dimensions towards the edge of the gingiva and up to the beginning of the blank block 1 to be processed.

The sub-gingival section 19 can extend between 0.5 and 8 mm, preferably at least 1.5 or 2 mm, from the blank block 1, and between 1 and 8 mm into the blank block 1.

The sub-gingival anatomic implant connecting part 14 can be made of the same material (ceramic, composite) as the to-be-milled blank block, or of a high-performance ceramic or of another suitable material, for example, metal or combinations of ceramic and metal. If it is made of high-performance ceramic or high-strength glass-ceramic or metal, it can be configured as a support element, which is positioned beneath the edge of the gingiva, for the dental crown made of the blank ceramic. If the blank block and the implant connecting part consist of two or more pieces they are connected by means of an adhesive made of biologically proven adhesives, by means of laminated glass, sintering or other mechanically and biologically suitable techniques for joining parts.

The sub-gingival section 19 of the connecting part 14 of the blank 10 shown in FIGS. 5-8 forms an important biological and functional part of the gingiva-sided surface of the finished crown.

As shown in FIG. 10, the sub-gingival section 19 can form an even larger gingiva-sided base plate of the crown, and it can have a convex outer surface 26.

Using the system according to the invention, before implanting the crown a healing cap (healing abutment) that forms the gingiva is placed on the implant that has a form corresponding to the outer surface 26 and impresses this form onto the gingiva during the healing process. The healing cap is then removed and the crown is attached. Thereby, the gingiva huddles against the outer surface 26.

In the embodiment of the invention described with reference to FIGS. 3 and 4, the formats for the dental crown to be made were determined by measurements in the patient's mouth. However, the invention is also suitable for use in a dental laboratory. For that, for example, a conventional impression of the to-be-restored row of teeth of the patient is initially made and a model 30 is cast there from, as shown in FIG. 11. A measurement abutment is placed in a conventional manner in the impression and thereby a corresponding implant 2 is placed in the model 30. The model 30 made in this manner represents essentially the situation according to FIGS. 1 and 2.

The form data for form-grinding the block 10 can be obtained from the model 30. In a possible embodiment, a wax-up abutment 29 is provided for that purpose, which has a body 31, for example, made of wax or another material that combines well with wax, and—similar to the blank—a sub-gingival anatomic implant connecting part 32. The latter fits on the implant 2 and can be fixed in it by means of a screw 22. To introduce and manipulate the screw 22 a channel 33 is provided within the body 31.

The dental technician attaches the wax-up abutment 29 to the implant 2′ of the model 30 and in known fashion waxes-up a dental crown 34 (or adapts a test form), which has the form of the tooth to be restored. The dental crown 34 is then removed from the model by loosening the screw 22 and placed into an optical or mechanical scanning device that records its form. In particular, the position of the channel 33 and the sub-gingival anatomic implant connecting parts 32 is thereby measured. The so-obtained data can be used for form-grinding the block 10, similar to the above-described method.

In the system according to EP 1 062 916, the integral parts (24) have a through hole (19). This bore is oriented perpendicularly to the area of the plate. In this form, the resulting integral part is suitable as a dental prosthesis only for implants that are completely axially parallel to the neighboring teeth. For the adaptation to implants that are oriented other than 90° with respect to the chewing surface or the: occlusal plane, this integral part, which forms the whole outer shape of the tooth, is not suitable.

This disadvantage is overcome by the solution presented here, in that during the CAD manufacture of the crown the occlusal surface of the crown is tilted with respect to the neighboring surface of the blank block according to the angular deviation of the axis of the implant from the occlusion perpendicular, as indicated in FIG. 9 by the tilted contour of a blank 10. This provides at the same time that the through bore or the screw channel is arranged with the same inclination to the occlusal surface of the crown.

As a consequence, the screw channel in the form-grounded crown does not exit in the center of the chewing surface, but depending on the angular orientation up to about 20° outside the center of the chewing surface. First tests show that this method is irrelevant for the aesthetics and the stability of the crown with the corresponding sealing of the screw channel. A crown made according to the invention can compensate for angular deviations from the occlusal perpendicular in interdental spaces of up to 20° and can be placed geometrically on the implant head without hindrance. The conventional angular compensation through the subsequent and separate manufacture of abutment and crown is unnecessary.

The blanks according to FIGS. 5-8 and 10 are provided with a holder 11, by which they are mounted to a processing tool. However, there are processing tools where the block 11 can be mounted without the holder 11.

For such processing tools the blocks 10 can be offered without the holder 11. For mounting the block 10 in the processing tool it is of advantage if the mounting occurs via one or more surface areas of the block that are traverse to the surface 13 so that the area of the implant-sided surface around the sub-gingival anatomic implant connecting part 14 and the corresponding area on the opposite side stay clear. For example, the block can be clamped on the surfaces 12, 12a, 12b and 12c (FIG. 6) by jaws of the processing tool. Since the implant-sided surface 13 in the area of the sub-gingival anatomic implant connecting part 14 as well as the corresponding area of the opposite side stay clear, the prosthesis can be constructed in known manner.

To simplify carrying out the invention, the practitioner can be offered a kit of parts that includes one or more blanks. In addition, the reference part 20 can be included in the kit of parts, as well as one or more closing plugs 23 and/or an abutment adapted to the outer surface 26 for forming the gingiva during the healing process and/or a selection of the above-described wax-up abutments 31. The kit of parts can further include screws and a suitable screw driver.

While the present application describes preferred embodiments of the invention it is clearly noted that the invention is not limited to them and may be practiced in different ways within the scope of the following claims.

1. Blank for manufacturing a dental prosthesis with a block (10) of a machineable material, wherein an implant-connecting part (14) is mounted on the block (10), in which an implant fixture with a seat (18) for a rotation-blocked attachment to an implant head is formed, characterized in that the implant-connecting part (14) lo has a sub-gingival section (19) that extends over an implant-sided surface (13) of the block (10) and that tapers towards the seat (18) of the implant fixture.

2. Blank according to claim 1, wherein a cross-section of the sub-gingival section (19) decreases from the surface (13) towards the seat (18) continuously and monotonically.

3. Blank according to any of the preceding claims, wherein a cross-section of the sub-gingival section (19) tapers from the surface (13) towards the seat (18) by at least 1 mm.

4. Blank according to any of the preceding claims, wherein the cross-section of the sub-gingival section in an area following the surface (13) decreases strictly monotonically.

5. Blank, in particular according to any of the preceding claims, for manufacturing a dental prosthesis with a block (10) of a machineable material, wherein an implant-connecting part (14) is mounted on the block (10), in which an implant fixture with a seat (18) for the rotation-blocked attachment to an implant head if formed, characterized in that the implant-connecting part (14) has a sub-gingival section (19) that extends over an implant-sided surface (13) of the block (10) and that has a pre-polished outer surface.

6. Blank according to any of the preceding claims, wherein the outer surface of the sub-gingival section has a surface roughness Ra<0.1.

7. Blank according to any of the preceding claims, wherein the outer surface of the sub-gingival section has a surface roughness of 0.5+/−0.01.

8. Blank, in particular according to any of the preceding claims, for manufacturing a dental prosthesis with a block (10) of a machineable material, wherein an implant-connecting part (14) is mounted on the block (10), in which an implant fixture with a seat (18) for the rotation-blocked attachment to an implant head if formed, characterized in that the implant-connecting part (14) has a sub-gingival section (19) that extends over an implant-sided surface (13) by at least 1.5 mm.

9. Blank according to claim 8, wherein the sub-gingival section (19) extends over the surface (13) by at least 2.0 mm.

10. Blank according to any of the preceding claims, wherein the sub-gingival section has a first, a second and a third subsection, wherein the first subsection connects to the surface (13), the second subsection to the first subsection, and the third subsection to the second subsection, and wherein the first subsection (19a) widens towards the implant-sided surface (13) and the second subsection and/or the third subsection widens towards the implant-sided surface (13).

11. Blank according to claim 10, wherein the second or the third subsection has a substantially constant diameter.

12. Blank according to any of the claims 10 or 11, wherein a height of the first and the third subsection ranges between 0.5 and 2 mm, and/or a height of the second subsection ranges between 0.5 and 4 mm.

13. Blank according to any of the claims 10 to 12, wherein the first subsection has an oblong cross-section.

14. Blank according to any of the preceding claims, wherein the sub-gingival section has exteriorly no rough edges.

15. Blank according to any of the preceding claims, wherein the blank has a holder (11) connected to the block (10) for attachment to a processing tool, wherein the holder (11) is placed on at least one holder-sided surface (12) of the block (10), and wherein the holder-sided (12) and the implant-sided surface (13) are arranged substantially perpendicular or traverse to each other.

16. Blank according to any of the preceding claims, wherein the implant-connecting part (14) is made of a different material than the block (10).

17. Blank according to claim 16, wherein the implant-connecting part (14) has a higher breaking strength than the block (10).

18. Blank according to any of the preceding claims, wherein the implant-connecting part (14) is a part producible separately from the block (10) and anchored in the block (10).

19. Blank according to any of the preceding claims, wherein a channel (16), which extends within the implant-connecting part (14) across the block (10), is provided for receiving a fastening screw for attachment on the implant head.

20. Blank according to any of the preceding claims, wherein the block (10) contains, or is made of lithium silicate ceramic.

21. Blank according to claim 20, wherein the implant-connecting part (14) is integrally formed with the block (10) and is likewise made of, or contains lithium silicate ceramic.

22. Blank according to any of the claims 1 to 19, wherein the block (10) is made of composite, feldspar ceramic or leucit glass ceramic or contains at least one of these materials.

23. Blank according to any of the preceding claims, wherein the implant-connecting part (14) has a convex outer surface (26) that protrudes over the implant-sided surface (13).

24. Blank according to any of the preceding claims, characterized in that it contains exactly one implant-connecting part (14).

25. Kit of parts for manufacturing a dental prosthesis with at least one blank according to any of the preceding claims.

26. Kit of parts according to claim 25, wherein it further comprises a reference part (20), which is attachable to the implant-connecting part (14) in a defined position for the mechanical determination of the position of the implant-connecting part (14).

27. Kit of parts according to any of the claims 25 or 26, wherein channel (16), which extends within the implant-connecting part (14) across the block (10), is provided for receiving a fastening screw for attachment on the implant head, and wherein the kit of parts further comprises a closing plug (23), which is insertable into the channel (16) and attachable therein.

28. Kit of parts according to claim 27, wherein a distance element (24) is provided on a tip of the closing plug (23) that is made of a different material than the closing plug (23) and/or has a smaller cross-sectional area than-the closing plug (23).

29. Method of manufacturing a dental prosthesis from a block (10) made of a machineable material, wherein an implant-connecting part (14) is mounted on the block (10), which extends over a surface of the block, in which an implant fixture for attachment to an implant head is formed, and wherein the block (10) is mounted in a processing tool and processed in the processing tool to remove material, characterized in that the block is processed in the processing tool, but not the implant-connecting part.

30. Method according to claim 29, wherein the block is connected to the processing tool on at least one holder-sided surface (12), wherein the implant-connecting part (14) is arranged on an implant-sided surface (13)., that is arranged transversely to the holder-sided surface (12) so that the implant-sided surface (13) stays clear at least in an area around the implant-connecting part (14).

31. Method according to any of the claims 29 or 30, further comprising the steps of
measuring the position of the implant-connecting part (14) by means of the processing tool, and
processing the block so that a predetermined prosthesis area is formed with respect to the implant-connecting part (14).

32. Method according to any of the claims 29 to 32, further comprising the following steps,
measuring a position and location of an implant head (3), wherein an auxiliary body (4) is attached to the implant head (3) so that the auxiliary body (4) is in predetermined position to the implant head (3), and wherein the position of the auxiliary body (4) is measured, and
processing the blank in consideration of the position and location of the implant head (3).
